(19) United States
(12) Patent Application Publication
(10) Pub. No.: US 2005/0177437 A1
(43) Pub. Date: Aug. 11, 2005

(54) E-commerce system

(76) Inventor: Jonathan Ferrier, Auckland (NZ)

Correspondence Address: Trexler Bushnell Giangiorgi;Blackstone & Marr, 105 West Adams Street, Chicago, IL, 60603, US

(21) Appl. No.: 10/312,926

(22) PCT Filed: Jun. 28, 2001
(86) PCT No.: PCT/NZ01/00127

(30) Foreign Application Priority Data
Jun. 29, 2000 (NZ) 505512
Dec. 19, 2000 (NZ) 509093

(51) Int. Cl. G06F 17/60

(52) U.S. Cl. 705/26

(57) ABSTRACT

The present invention provides an E-Commerce system where a purchaser is able to purchase goods from a supplier having a website on a network such as the Internet. Payments for the purchased goods is facilitated through a gateway, which also provides for collection and delivery of the purchased goods to the purchaser by way of a delivery entity. The delivery entity is contracted by the gateway to collect the goods from the supplier's warehouse and deliver it to the purchaser. The purchaser may pay for the goods at time of purchase, where finds are held in an escrow account until authorisation by the purchaser to release these funds to the gateway is made at the point of delivery. Alternatively, the purchaser may choose to pay for goods via a mobile electronic funds transfer device upon delivery.

### BACKGROUND TO THE INVENTION

1. Field of the Invention

The present invention relates to the electronic funds transfer at point of sale payment in exchange for goods and services purchased over a public communication network, such as the Internet. In particular the present invention relates to the buying of merchandise via the Internet and payment by way of electronic funds transfer upon delivery of the merchandise.

2. Description of the Prior Art

It is well known in the art for payments to be made for goods and services purchased over the Internet by way of a secure payment transmission to a merchant via a payment gateway that returns a certification that may include a credit verification to allow a merchant to determine whether to accept or reject payment for goods. Once payment is accepted, the goods are then sent via post or courier to the purchaser.

There are many different ways for implementing payments over the Internet. This can be by way of e-money or the secure transmission of credit card or debit card details, to name a few examples.

Numerous proposals have been made for some form of electronic money that can be used in cashless payment transactions as alternatives to traditional currency and cheque types of payment systems. Such systems are disclosed in U.S. Pat. No. 4,977,595 of Nippon Telegraph and Telephone Corporation and U.S. Pat. No. 4,305,059 of Benton.

It is desirable for a merchant to obtain information from a customer and transmitted over a publicly accessible network, such as the Internet, to the merchant, without risking the exposure of the information to interception by third parties that have access to the Internet, and to assure that the information is from an authentic source. Furthermore, it is desirable for the merchant to transmit information, including customer information over the Internet to a payment gateway computer system that is designed to authorise a commercial transaction on behalf of a financial institution, without the risk of exposing that information to interception by third parties. Such institutions include, for example, financial institutions offering credit or debit card services. One such attempt to provide such a secure transmission channel is the secure payment technology such as Secure Electronic Transaction (hereinafter SET), other such secure payment technologies include Secure Transaction Technology (STT), Secure Electronic Payments Protocol (SEPP), Internet Keyed Payments (iKP), Net Trust and Cyber-Cash Credit Payment Protocol. Such secure payment technologies require the customer to operate software that is compliant with the secure payment technology, interacting with third party certification authorities, thereby allowing the customer to transmit encoded information to a merchant, some of which may be decoded by the merchant, and some which may be decoded only by a payment gateway specified by the customer.

Another such attempt to provide a secure transmission channel is Netscape Inc.'s Secure Sockets Layer (hereinafter SSL). SSL provides a means for secure transmission between two computers. SSL has the advantages that it does not require special purpose software to be installed on the customer's computer because it is already incorporated into widely available software that many people utilise as their standard Internet access medium and does not require that the customer interact with any third party certification authority. SSL does not provide a mechanism for transmitting encoded information to a merchant for retransmission to a payment gateway such that a subset of the information is readable to the payment gateway but not to the merchant.

Internet based payment solutions require additional security measures that are not found in conventional POS terminals. This additional requirement is necessitated because Internet communication is done over publicly accessible, unsecured communication lines in contrast to the private, secure, dedicated phone or lease line service utilised between a traditional merchant and an acquiring bank. Therefore, usually any solution utilising the Internet as a communication system, employs some form of cryptography.

Digi-Cash (a company based in Holland and the United States) has developed several different payment schemes that provide security and privacy using public key cryptography. These systems allow fully anonymous secure electronic cash to be used on the Internet. It provides the privacy of paper cash with the added security required for open networks. Such a system, for example E-Cash, has as participants a customer, a merchant and a bank. Customers and merchants have accounts at an E-Cash bank and customers withdraw coins against their account and store them in their E-Cash wallet software that resides on their computer. The wallet stores and manages a customer's coins, keeps records of all transactions, and makes the protocol steps appear as transparent as possible to the customer. The withdrawal protocol prevents the bank from being able to see the serial numbers of the coins it is issuing. A customer can later use coins to pay a merchant. At the time of purchase, the merchant must forward the coins to the minting bank to ensure that they have not already been spent. If the coins are valid, they will be deposited into the merchant's account. The merchant can then send the purchased goods or a receipt to the client. The merchant can also make payments to a client using the same procedure. E-Cash is normally integrated with the Internet at present. The client runs the Cyber wallet software and a web browser side-by-side. When an order is selected from a merchant's web page, the merchant's E-Cash software is automatically started by means of a Common Gateway Interface (CGI) script. The CGI simply provides a means of running a program from a web server and allowing it to pass back results through that server. The merchant software proceeds with the E-Cash purchase as before. If the payment was successful, the item or purchase indication may be returned through the web to the client's browser. This method has the advantage that it can be easily integrated with most web browsers and servers.

There are many problems paying for goods over the Internet. Firstly, there are security issue concerns when paying by credit card over the Internet, in that a third party may intercept any data being transmitted to a merchant and use the information included in the transmitted data for fraudulent activities. Therefore, there tends to be some consumer resistance to paying for merchandise in this way. Another problem occurs when the purchaser provides a merchant with his/her private details. The merchant may use these details for unsolicited mail, or may sell or pass on these details to other merchants. Therefore, a higher level of privacy between the merchant and purchaser would overcome these problems.

Furthermore, current transactions are usually carried out in the currency of the merchant. It is therefore difficult for the purchaser to be fully aware, at the point of online purchase, what the full cost of the purchase is, as there are other factors that must be considered, for example currency changes, added delivery, customs and duty costs. Purchasers of goods off the Internet use many forms of payment. Currently, the main form of payment supplied by online merchants is credit card, but emerging payments systems which present the merchant with the problem of having to facilitate a number of separate payment systems.

Furthermore, encryption methods can be costly to implement and difficult to use. The merchant may be prone to bad debts in that their customers may pay for goods using an unapproved payment method, for example, payment by credit card where a credit check is not obtained. One final problem that may occur in the above mentioned systems, is that the customer has paid for merchandise before they receive it. In the event that the customer is not satisfied with the merchandise it is possible that they may not be able to return the merchandise and obtain a refund.

### SUMMARY OF THE INVENTION

It is therefore an object of the present invention to provide an E-Commerce trading system that overcomes the above mentioned disadvantages, or at least to provide the public with a useful choice.

Accordingly the present invention consists in a system which facilitates the purchase, delivery and payment for goods by a purchaser from a supplier who sells goods from a website, where an entity operating a gateway enables said supplier to provide said purchaser with a payment option via said gateway and said gateway accepts liability for paying said supplier and a delivery entity conveys said goods from said supplier to said purchaser and collects payment from said purchaser, comprising the steps of:
a) said supplier registering with said gateway entity by providing said gateway with collection details such as an address to collect said goods from said supplier,
b) said purchaser viewing on a web enabled device said suppliers website, said purchaser selecting goods as displayed on said website by using a pointing device associated with said device and causing each selected good to be added to an electronic file forming part of said website,
c) said purchaser using said pointing device to select a payment option displayed on said website,
d) said purchaser being thereupon directed to said gateway and said electronic file being sent to said gateway,
e) said purchaser then either,
registering with said gateway providing said gateway with information which uniquely identifies said purchaser and said gateway assigns a unique identification number to said purchaser, or
if already registered, entering an already assigned unique identification number, to cause an electronic purchase order to be created by said gateway, which includes transaction identification information,
f) said purchase order with purchaser identification information omitted then being forwarded from said gateway to said supplier,
g) said gateway entity then forwarding said purchase order, said collection details of said supplier and some or all of the contents of said purchaser identification information to a delivery entity,
g) said delivery entity collecting said purchased goods from said supplier and delivering said goods to said purchaser, where upon delivery said purchaser makes a payment to said delivery entity for said goods, and
h) said payment being transferred to said gateway entity.

In a further aspect the present invention consists in a system which facilitates the purchase, delivery and payment for goods by a purchaser from a supplier who sells goods from a website, where an entity operating a gateway enables said supplier to provide said purchaser with a payment option via said gateway and said gateway accepts liability for paying said supplier and a delivery entity conveys said goods from said supplier to said purchaser and collects payment from said purchaser, comprising the steps of:
a) said supplier registering with said gateway entity by providing said gateway with collection details such as an address to collect said goods from said supplier,
b) said purchaser viewing on a web enabled device said supplier=s website, said purchaser selecting goods as displayed on said website by using a pointing device associated with said device and causing each selected good to be added to an electronic file forming part of said website,
c) said purchaser using said pointing device to select a payment option displayed on said website,
d) said purchaser being thereupon directed to said gateway and said electronic file being sent to said gateway,
e) said purchaser then either,
registering with said gateway providing said gateway with information which uniquely identifies said purchaser and said gateway assigns a unique identification number to said purchaser, or
if already registered, entering an already assigned unique identification number, to cause an electronic purchase order to be created by said gateway, which includes transaction identification information,
f) said purchaser making a payment for said goods using online payment means, where said payment is transferred to an escrow account maintained by said gateway,
g) said purchase order with purchaser identification information omitted then being forwarded from said gateway to said supplier,
h) said gateway entity then forwarding said purchase order, said collection details of said supplier and some or all of the contents of said purchaser identification information to a delivery entity,
i) said delivery entity collecting said purchased goods from said supplier and delivering said goods to said purchaser, where upon delivery said purchaser uses the delivery entity to communicate authorisation for the release of said payment from said escrow account to said gateway, and if necessary making a supplemental payment to said delivery entity for said goods and said delivery entity transferring said supplemental payment to said gateway.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples.

One preferred form of the present invention will now be described with reference to the accompanying drawings in which;

### BRIEF DESCRIPTION OF THE DRAWINGS

FIG. 1 is a block diagram of the preferred embodiment of the present invention, showing each participant in the system,

FIG. 2 is a flow diagram of the supplier registration process,

FIG. 3 is a flow diagram showing the process a purchaser follows when buying goods over a public network, such as the Internet,

FIG. 4 is a block diagram of a further preferred embodiment of the present invention including the transaction feedback forum,

FIG. 5 is a diagram showing the payment methods of the present invention and the interactions between the purchaser, supplier and gateway, and

FIG. 6 is a diagram showing the transactions made for online purchases using the present invention.

### DETAILED DESCRIPTION

The present invention provides an E-Commerce system where a purchaser is able to purchase goods from a supplier having a website on a network such as the Internet. Payments for the purchased goods is facilitated through a gateway, which also provides for collection and delivery of the purchased goods to the purchaser by way of a delivery entity. The delivery entity is contracted by the gateway to collect the goods from the supplier's warehouse and deliver it to the purchaser. The purchaser may pay for the goods at time of purchase, where funds are held in an escrow account until authorisation by the purchaser to release these funds to the gateway is made at the point of delivery. Alternatively, the purchaser may choose to pay for goods via a mobile electronic funds transfer device upon delivery.

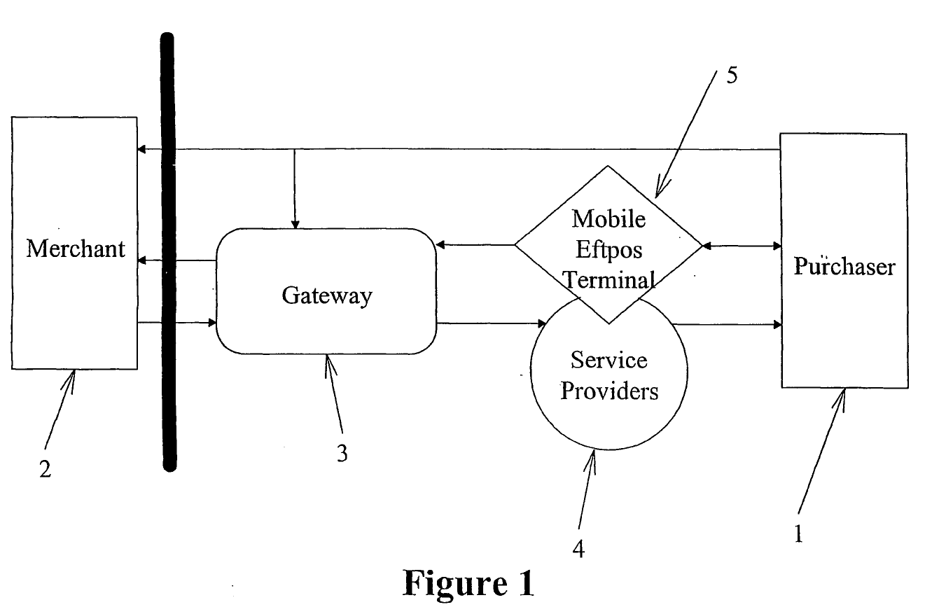

Referring to FIG. 1, the preferred embodiment of the present invention consists of a purchaser 1, purchasing goods from a supplier 2, and making payments for the purchased goods through a gateway 3, thereby the personal details of the purchaser are not seen by the supplier 2. The gateway 3 provides for collection and delivery of the purchased goods by way of a delivery entity 4. The delivery entity 4 is contracted by the gateway 3 to collect the goods from the supplier's warehouse and deliver it to the purchaser. Upon delivery the purchaser may pay for the goods using Electronic Funds Transfer (EFT) as the delivery 4 will have available to the purchaser 1 a mobile EFT terminal 5 that allows for instantaneous payment. The payment is preferably made using a debit card or smart card using EFT, but may be made using cash, cheque or credit card.

Supplier Registration

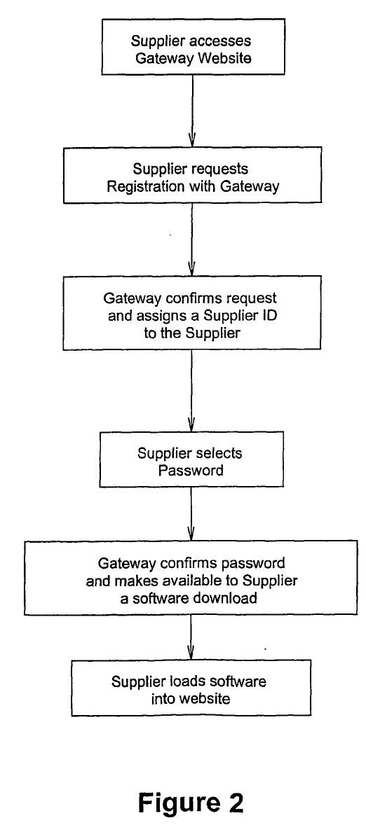

FIG. 2 shows the supplier registration process. The first step of this process is the supplier 1 accessing the gateway website 3 using a computer that is enables connection to the Internet. The supplier then signs up with the gateway by filling in a registration form as provided on the gateway website. This form includes, but is not limited to, account information for payments, contact details, the location for collection of goods, the delivery entity being used, the conversion protocols used for foreign currency collection and the digitally signed terms of doing business through the gateway 3. Next the gateway confirms the suppliers request form ensuring that all information required has been provided. This confirmation, (which is preferably by way of an E-mail to the supplier), also gives a unique supplier identification number (ID), created upon setup of an supplier account with the gateway. The supplier ID enables the supplier to be identified by the gateway for each purchase that is transacted for through the gateway. The supplier is then required to log-on to the gateway website and select a unique password that will be entered in conjunction with the supplier ID allowing for added security. The gateway will then confirm the password and the supplier is given access to software to be down loaded. Once this software, preferably templates and protocols, is down loaded and implemented on to the supplier website, the supplier will be able to provide the purchaser 1 with a payment option via the gateway 3. The gateway protocols will be integrated into Commerce Service Provider Solutions (CSPS) and the commercial shopping cart packages to allow the supplier to use these packages and be able to process transactions created by these packages and send these to the gateway website in the form of an electronic file.

Once the software has been loaded into the supplier website an option, preferably in the form of a button, is created on the supplier website. When this button is selected by the purchaser, the supplier details and purchased items stored in an electronic file are sent to the gateway. The purchaser is able to view parts of this information via the gateway and is able to confirm details such as, information regarding the value of goods purchased, delivery options, costs and payment information.

Once the supplier has registered with the gateway and added the gateway option to their checkout process (which is usually a shopping cart), the supplier, after the purchaser has selected the gateway as the preferred method of payment, sends purchase information to the gateway as described above. This causes the secure gateway payment window to open and after the purchaser has entered a unique purchaser identification number and password, a digital signature is created wherein the purchaser agrees to the terms of the purchase. Here the gateway automatically identifies the purchaser, or if the gateway cannot identify the purchaser, for example, when the purchaser is not registered with the gateway, the gateway activates a new registration as detailed below.

Additionally the gateway will also be able to operate in the same manner as a credit card company currently does on any existing E-Commerce enabled websites. Instead of entering a credit card number the purchaser enters their unique gateway purchaser identification number. This number is transmitted to the gateway along with the supplier identification number. The gateway then transmits the transaction identification number that indicates to the supplier the method of payment is to be via the gateway. This method enables registered gateway users, namely purchasers 1, to shop with ease over the Internet and ensures universal acceptance of their credit card. Also this method of implementation into a supplier website provides less difficulty than the method as described above, meaning existing supplier websites that currently accept credit cards can seamlessly and readily process gateway transactions without the need to download software from the gateway website.

Purchaser Registration

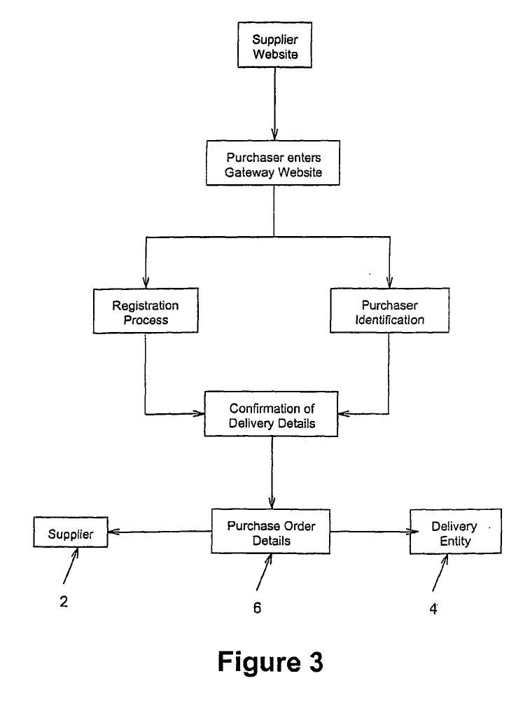

With reference to FIG. 3, during the purchasing process a purchaser 1 may register with the gateway 3. To do this the purchaser may either independently access the gateway website using a computer that allows connection to the Internet, and therefore access to the gateway website, and register as a purchaser. The purchaser, after entering the supplier website and selecting various items (using a pointing device such as a mouse that is connected to their computer), may select an option to pay via the gateway. This can be by way of a buy button or by entering in the credit card field on the supplier website a gateway registration ID. This registration ID is promoted on the supplier website payment page that when entered in the credit card field brings up the gateway registration page on the purchaser's computer screen.

In the case of registration after purchase, the purchaser, once entering the gateway website, is prompted to register with the gateway. If the purchaser has registered previously with the gateway the purchaser will be prompted to enter a unique purchaser identification number and may be prompted to enter a password confirming the identification number. If the purchaser requests to register with the gateway, the gateway provides a registration page that allows the purchaser to enter their customer details. These customer details include, but are not limited to, name, contact details (such as, delivery address, phone number and E-mail address), the preferred method of payment and other such information. Upon completion of the form the purchaser is entered into the gateway computer and accounting system. At this stage the gateway may perform a credit check on the client, although this is not always necessary as usually payment is made for the goods on delivery and the purchase will not be handed the goods until he or she has paid for them. Once the gateway completes the registration process the gateway creates and returns a unique purchaser identification number to the purchaser, this is preferably by way of a E-mail. The purchaser will then be required to return to the gateway website and enter the purchaser identification number and select a password for this identification number. Once the gateway has confirmed the password the purchaser may continue with the purchasing and payment options as described below.

Within the purchaser registration process the purchaser agrees and digitally signs terms and conditions which govern the validity of the purchase in the event of the purchaser refusing to pay for the goods on delivery. This gives the gateway the ability to recover delivery, return delivery and restocking costs. There may also be a deposit mechanism which will be effectively in the form of a direct debit to the purchasers Internet service provider account or telephone account to recover the cost of delivery in the event of non-acceptance of goods on delivery. This undesirable activity will also be registered on the gateway for control purposes. The gateway will also have the right to adjust delivery charges in the event that the address is changed or redirected from the original delivery address.

Purchasing Process

With reference to FIGS. 1 and 3, the purchaser 1 after selecting various goods he or she wishes to purchase from a supplier 2 website that is registered with the gateway 3, the details of these goods most likely being put into a shopping cart of some sort, the cart preferably being an electronic file, the purchaser 1 is given a number of options in which to pay for the goods. The purchaser 1 may then choose to pay via the gateway 3, at which point the purchaser will be directed to the gateway website 3. If the purchaser is not already registered he or she will register as detailed above.

Upon entering the gateway 3, the purchaser 1 is prompted to enter their unique purchaser identification number and may also be prompted to enter a password. The identification number and password are confirmed by the gateway and the purchaser is provided with their confirmation details such as the delivery address, cost of goods and time in which the goods are to be delivered and may alter the delivery details as he or she wishes, but not the purchase details such as the purchased goods and their cost.

The purchaser can then check the progress of the delivery through the gateway 3 at any future time using a link provided by the gateway 3 to the delivery entity 4. The delivery entity 4 is preferably a courier that can be accessed via the Internet. The gateway 3 verifies the delivery address, contact details and preferred delivery time with the purchaser 1, as well as confirming the payment method from a drop down list which enables the purchaser to pay on delivery, using mobile electronic funds transfer (MEFT) or use traditional online payment methods, that usually are confirmed by the purchaser's digital signature. The gateway may verify the purchasers right to use the gateway to the supplier 2 and may also advise the supplier 2 if the purchaser is a new registration or a regular purchaser. Once the purchaser has altered and confirmed the delivery details, a purchaser order 6 is sent to the supplier 2 as well as to the delivery entity 4. The purchase order 6 sent (preferably by E-mail) to the supplier 2, details a unique transaction identification number, the transaction value and the collection status, that status being the time in which the purchaser wishes to have the goods delivered to them. The purchase order 6 sent to the supplier does not include any personal details of the purchaser 1, such as, delivery address, purchaser E-mail address or payment method details, therefore privacy is maintained between the gateway and purchaser. As mentioned above, a copy of such a purchase order 6 is sent to the delivery entity (courier company) who collects and delivers the goods to the purchaser. The purchase order sent to the courier company includes, but is not limited to, the collection and delivery details of the goods, a transaction identification number (transaction ID), a transaction value and the preferred time in which the goods should be delivered to the purchaser 1.

Payment

Once the courier company 4 has collected the goods from the supplier 2 the courier 4 will deliver the goods to the purchaser 1. Upon receipt of goods the purchaser pays for the goods by way of a MEFT terminal 5 the courier is equipped with. This payment can be made using a debit card, a credit card, a smartcard, cash or cheque. Although, preferably the first transaction through the gateway after registration by the purchaser is by payment on delivery. This enables the authentication of the purchaser to the gateway at which time the gateway may also request additional identification, for example, a utility account number, passport or security card or the like. Here the courier 4 enters the transaction ID, either manually or using a barcode scanner, so that the payment can be tracked and transaction value into the terminal 5 (as shown in FIG. 1) or in the case of cash the transaction recorded through the MEFT and the cash packaged for deposit into the gateway's bank account. If paying by debit card or smartcard the purchaser will swipe the card through the card reader and enter an appropriate personal identification number (PIN) using the numeric keypad. This payment is then transferred via wireless analogue or digital networks to a clearing house which moves the transaction into an appropriate account wherein the payment has attached to it the unique transaction identification number that allows the payment to be identified and associated with the appropriate purchaser 1 and supplier 2. The payment is then redirected automatically from the gateway bank account to the supplier bank account less any service fee the gateway may charge.

If the purchaser wishes to pay by credit card, once the courier has entered the transaction details into the MEFT terminal, the purchaser will swipe the credit card through the card reader on the MEFT terminal, once approved, a receipt is printed where a signature is taken, either the purchaser signs the receipt or using an electronic signature reader device the purchaser enters a unique PIN. Again, the payment is transmitted to the gateway account in the way as detailed above.

If the purchaser wishes to pay by cheque, the courier logs the cheque details for approval by Telecheck or a similar approval service. A receipt is given and the cheque is processed through the gateway account and transferred to the supplier account less any service fee the gateway may charge the supplier.

Alternatively, if the purchaser, after selecting goods he or she wishes to purchase from the supplier website, the purchaser may pay by a pre-payment facility. Alternatively, if the gateway is aware that the purchaser is a credit risk the gateway may require at least a partial payment of the cost of goods to be paid by the purchaser. The purchaser in the gateway chooses the “prepay escrow” method of payment. Via this method the purchaser may pay for the goods using an online credit card payment, direct debit, or any other online payment mechanism such as through an account with the gateway. In the case of escrow payment by credit card the gateway will require the purchaser to enter the credit card type, the name on the card, expiry date and credit card number. Here, money is transferred from the credit card into a prepay escrow account held by the gateway. In the case of direct debit a bank authorisation would be lodged with the gateway before this option is first used. When selecting this option the purchasers bank account would be debited and a prepay escrow account held by the gateway credited. The funds will be held by the gateway in escrow until the purchaser authenticates and authorises payment. At the point of delivery the purchaser authenticates delivery, once the goods have been received, through the mobile electronic funds transfer terminal and delivery entity and authorises the release of funds from the prepay escrow account to the gateway and the funds (or part thereof) will be transferred in the usual way to the supplier.

As a further alternative, the purchaser may pay for purchases using a part payment into a prepay escrow account and then complete the payment by paying via, credit card, debit card, cheque or cash at the point of delivery via the mobile electronic funds transfer terminal.

Prepay escrow may be used for convenience of the purchaser, or because the purchaser does not have the facilities to pay at the point of delivery, or if the purchaser is purchasing goods as a gift and so delivery is at another address or alternatively, the purchaser has a history of being unable to pay at the point of delivery.

Gateway

The gateway 1 also has the ability to track and trace the goods back to the courier 4. The purchase order has within it details of a transaction ID, comprising a supplier identification number, purchaser identification number and transaction identification number, this ID is used as a reference for E-mail traffic to and from the supplier 2 and purchaser 1. The E-mail conduit will be separate from the main gateway to control spurious E-mail viruses and prevent unauthorised access to the main gateway. Furthermore, the gateway can hold credit card details of the purchaser if the purchaser wishes to pay online and have the goods delivered to a alternate address, for example, if the purchaser wishes to have goods delivered to a location where no one is available to receive the goods and pay for them. In this situation included in the transaction details would be a transaction value of zero, as on delivery no payment would be required to be paid.

The gateway is able to keep a record of each transaction and its details, such as delivery and payment details relating to each purchase. The purchaser can enter the gateway at any time and check a transaction using the transaction ID or by browsing through a list of transactions that only the purchaser has access to once their unique purchaser ID and password has been entered into the gateway webpage.

The gateway also provides a conduit for E-mail traffic between the purchaser and the supplier, this enables the gateway to protect the purchaser's E-mail address if the purchaser chooses. If the supplier wishes to communicate with the purchaser they will reference the purchaser using the transaction ID through the gateway, who will pass all communication onto the purchaser. Once payment has been made the gateway can confirm delivery and payment of the goods preferably by E-mail. Confirmation is made to the supplier and the purchaser. The gateway has the ability to consolidate multiple transactions within common delivery time frames, thus having the purpose of reducing delivery costs.

Once the payment has been made via the MEET terminal and courier, the funds are transferred from the courier to the gateway. The gateway will pay a fee to the courier for delivery of the goods, and will transfer the purchase price to a supplier bank account. This purchase price is less any commission and costs associated with the gateway service functions.

The gateway also allows the supplier to have a capability to track and trace the delivery of the goods to the purchaser only in terms of whether the goods have been delivered and paid for. This allows the supplier to query the gateway as to the status of the goods.

Another aspect of the present system is to provide purchasers, through the gateway, a relationship with their preferred bankers. This will allow banks to participate in the e-commerce transaction loop, which is currently not possible. This is because banks are customer centric and have found it difficult to insert themselves into the transaction loop as they service their client base in a highly localised geographic environment linked to their clients.

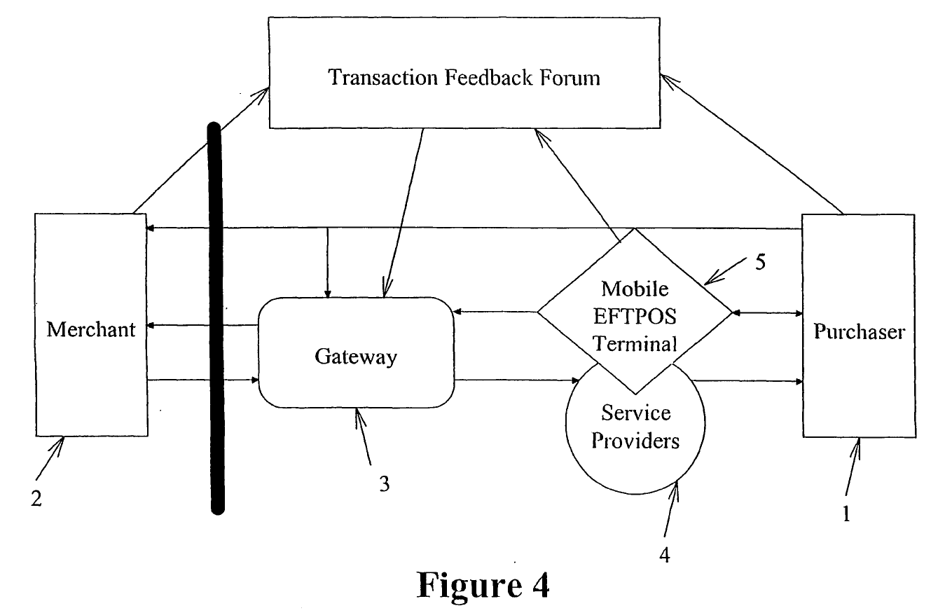

The purchaser bank relationship created within the gateway can broadly be described as facilitating the customer centric aspect of banking into the online world. So that the gateway will have the links with merchants globally and cater to the needs of many purchasers, which in turn, can maintain their relationship with their individual banks if they wish. The combination of the trusted relationship between bank and purchasers with the gateway's privacy control and separation from merchant websites is illustrated in FIG. 4. This relationship will provide banks with a strong platform to service their clients in the new e-commerce economy. This relationship stands to also provide a further level of authentication from the purchaser and allow the purchaser to learn to trust using the Internet.

The gateway has the ability to allow the purchaser on registration, or at any subsequent date, to nominate its preferred banker. The gateway will either allow the bank to have a portal attachment brought up for online payments in the form of online direct debit with the banks identity represented or for the gateway to set up a direct debit authority between the purchasers preferred bank account and the gateway. Either way approval for finds is made online or at point of delivery with the gateway as the beneficiary and fulfilment can proceed.

Another aspect of the gateway is for the purchaser's bank to provide mobile banking services facilitated through the gateway. This situation allows the bank to go to the client rather than the client go to the banks. This service broadly covers deposits, transfers, withdrawals, online loan document serving, travel funds etc, and can also cater for online bill payments.

Referring now to FIG. 4, a transaction feedback forum is preferably formed and administered by the gateway, which allows feedback from all participants in a fixed format with comment for automatic processing. This forum allows transaction performance to be fully monitored. The participants of the forum are merchant websites 2, service providers 4, purchasers 1, and the gateway 3. Each participant via the forum is able to monitor and feed back performance to each of the other participants. From this is created a response system that allows for notification and follow up by each participant in the case of adverse performance.

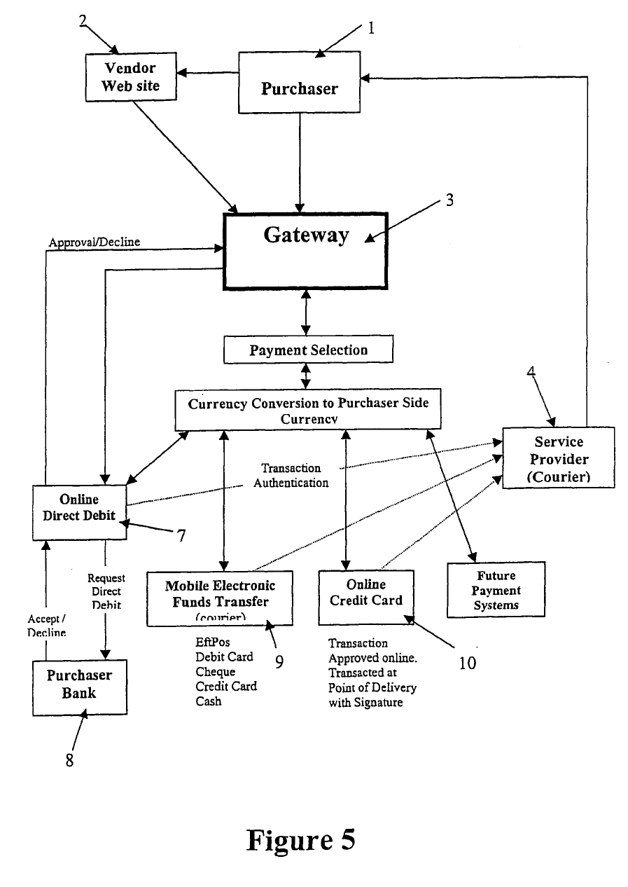

Referring now to FIG. 5, the gateway works with the purchaser's bank in that when a purchaser 1 makes a purchase via a merchant website 2, the purchaser 1 may choose to pay for the goods via the gateway 3. If so, the purchaser is given the choice of method of payment. Some examples being MEFT 9, online credit card 10, online direct debit 7 (once setup is approved through the purchaser's bank) or other online payment mechanisms. If the purchaser 1 wishes to pay via the gateway 3 via an online direct debit payment 7 the gateway 3 will request a direct debit from the purchaser bank 8 and the bank approves or declines the transaction and notifies the gateway 3.

In order to facilitate the transferal of collected payments from the gateway to the merchant a direct credit account is required to be set up between the merchant's bank account and the gateway. Included in the purchase price of the goods is any additional costs such as shipment costs, tax and duty, therefore these need to be able to be managed by both the merchant and the gateway. It is envisaged that the merchant will pay for additional freight costs in the event of a split shipment. Although, the merchant will determine who pays for the shipping of the goods and define shipping payments in a Merchant Operational Options setup. Depending on the Merchant Operational Option selected by the merchant at the point of registration with the gateway it is possible that these costs can be shifted to the purchaser if the purchaser wishes for the merchandise to be sent to them by the fastest means possible. For local transportation costs it is envisaged that these will be built into the merchant price and deducted through the gateway and paid to the service provider. Alternatively, transportation costs could be additional to the purchase price and the gateway separately charges the purchaser and pays this to the service provider.

With regard to tax payments or duty, any tax or duty payable on the merchant side is managed by the merchant and preferably built into the purchase price. For any tax or duty payable on the purchaser side the merchant will also manage. This is also preferably built into the purchase price but is deducted by the gateway and paid to the relevant authorities.

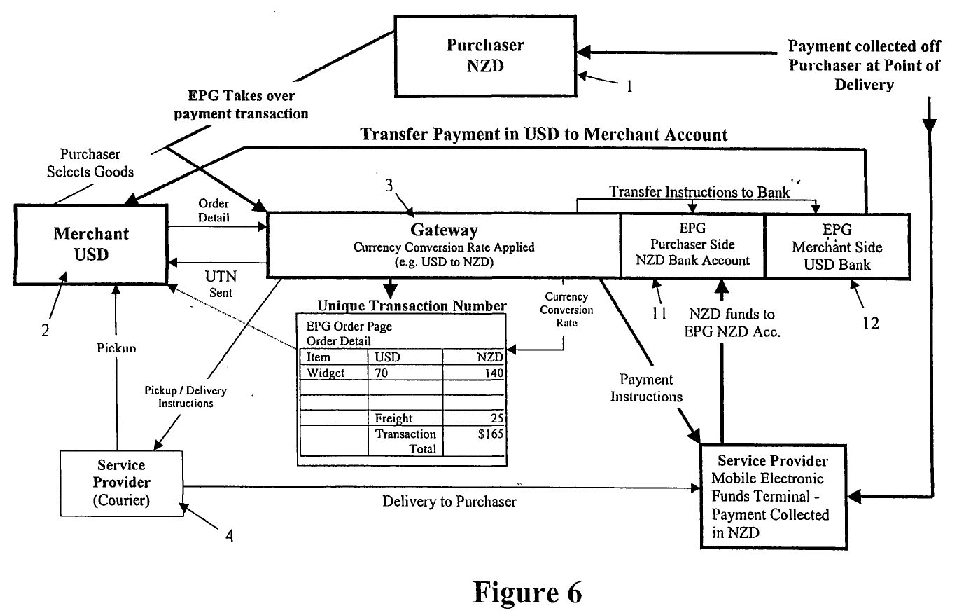

Referring now to FIG. 6, which shows the transaction path when a purchaser 1 makes a purchase from a merchant 2 via the gateway 3 of the present invention. Preferably the purchaser side transactions are always collected transactions are always collected (preferably by MEFT equipped courier 4) in the purchaser side currency, which is shown in New Zealand dollars in the example transaction path of FIG. 6, regardless of the payment method used. Funds collected are payable to the purchaser side domiciled bank account of the gateway 11. From here the funds are transferred, after a currency conversion, to the merchant and service provider domiciled bank accounts 12 managed by the gateway to ensure funds are paid out to the merchant. In the example of FIG. 6 the merchant is paid in United States dollars.

During the payment process, the unique transaction number will follow the payment so that it is easily trackable. There will also be provided within the merchant identification number a link which describes the sellers currency. This link resides within the transaction document order details. Also, provided within the purchaser identification number is a link which describes the conversion to the purchaser's currency. Furthermore, there is a link from a currency list using currency code to reference listed exchange rate to produce the purchaser's cost. The quoted exchange rate is tracked at the purchaser side exchange rate at the time of ordering to the actual conversion from the gateway bank account to the merchant bank account to monitor performance on the currency exchange rate time of purchase and at time of fulfilment and payment to the Merchant and service provider.

This provides an audit path for each transaction and each merchant account, which shows unders and overs. Interface formats will be provided to merchants and service providers, as well as interfaces with services that may be added including interface will bill payment systems, returns management portals, such as ReturnValet (a returns management solution for both purchasers and merchants which allows seamless return of unwanted goods with a prompt credit paid).

In the preferred form of the present invention each transaction is confirmed via email to the merchant, purchaser and the service provider. The unique transaction number identifies participants in the transaction and is a link to the unique seller number and unique purchaser number. The unique transaction number is used as a reference for E-mail traffic to and from the supplier and purchaser. This prevents unauthorised use of email addresses but enables the parties to communicate in the event of a problem. Also, there is a facility where the purchaser, if requested, can receive promotions from any supplier. The E-mail conduit will be separate from the gateway to control spurious E-mail viruses and prevent unauthorised access to the gateway. If the email to the purchaser is successful, the transaction is carried out and the merchant and purchaser are notified of completion of the transaction.

Where the goods are to be returned to the merchant due to the goods being damaged or incorrectly delivered, the purchaser will be given a full refund. Here, if the purchaser changes his/her mind about the goods and is within the stated consumer laws of the purchasers country, then return of the goods to the merchant will be made and a refund to the purchaser made, this refund will usually be the purchase price less shipping costs to and from the purchaser. The gateway will supply a calculated refund in the returns process. Also, returns can be managed through localised returns portals such as www.ReturnValet.com.

The relationship between the gateway, service provider and purchaser will now be further described. On registration a purchaser will be required to transact their first transaction as payment at point of delivery to authenticate themselves. This first transaction can be carried out using EftPos, Debt Card, Credit Card with signature, Cheque through Telecheck or Smart Card. These transactions are facilitated through the MEFT terminal along with the unique transaction number tracking and are preferably carried out online. If signal security is low at point of delivery the payment details will be captured and stored were the service provider will move to a point were there is signal security (either the service provider vehicle or other point) and will return to complete delivery. If the purchaser has selected the online credit card payment option at registration as a payment option for the future they will be required to procure the card and signature (through signature capture) as authentication. Once the service provider moves to a signal secure location, out of signal security transactions stored are transacted. The service provider then returns for delivery transactions after the first two purchaser transaction can be any of the above methods including online direct debit and cash at point of delivery. Or any other payment system that may be developed.

The payment methods available to the purchaser via the gateway will now be described. Firstly, the purchaser may pay on delivery of goods. Here the first transaction carried out via the gateway is verified by payment on delivery. Upon delivery, if the signal security at the service provider, in particular a courier with a MEFT terminal, is not satisfactory to carry out the transaction at the point of delivery, the transaction is stored and the terminal moved to a secure signal zone for online authorisation and returned to the point of delivery to complete the transaction. If the purchaser has selected online payment options, such as online credit card, then the card must be sighted and signature captured with authority taken by the service provider on delivery authorising future online transactions (with signature on file) for future online credit card payments.

Furthermore, online payment can be made via a direct debit. A direct debit can be set up by selecting this payment option at purchaser registration, it is envisaged that a 3-14 day lead time is required for direct debit setup. This process is achieved by the gateway setting up the direct debit authority with the purchaser and purchaser bank or via a Bank Portal interface were the purchaser transacts the direct debit as a bill payment. When the gateway receives verification of accepted payment, the gateway proceeds with fulfilment of the purchase in the purchaser side currency. Preferably this form of direct debit can be carried out at point of delivery if the purchaser nominates this.

Also, a credit card may be used to pay for purchases online. Here transaction approval is made online which in effect reserves funds, where transferral of funds occurs once the transaction is completed at point of delivery with signature capture either carried out with the MEFT terminal or stored until signal secure transmission can take place. The purchaser side transaction is always collected, preferably by a MEFT terminal equipped courier, in the purchaser side currency regardless of the payment method used. The funds collected are payable to the Purchaser side domiciled bank account of the gateway. From here the funds are transferred after the performance of a currency conversion to the merchant side domiciled bank account of the gateway so that funds can be paid out to the merchant. The unique transaction number always follows the payment transferrals so as to keep track of the payment. The above protocols verifies to a large degree the authenticity of the purchaser and reduces the amount of online fraud.

To further ensure payment a purchaser will be required to accept a Purchasers Obligation Agreement. This will cover obligations of the purchaser in the event that they refuse delivery and payment of a transaction carried out. For example, for overseas transactions the purchaser will be liable for all freight and associated costs if he or she wishes to return the goods. This will be managed by the direct debit or credit card authority to cover such non-performance. Alternatively, the merchant will have the option of accepting responsibility of this cost, in which case the merchant will be liable for any returned goods.

Returns Process

If the purchaser finds the goods are damaged or there has been a mistake in the product delivered by the merchant, the purchaser may return goods and the merchant will use their best endeavours to replace the goods. The return of an order can be divided into two categories, prior to payment being made, and after payment has been made.

The return of an order prior to payment being made will primarily be where the purchaser is not satisfied with the order when the delivery agent delivers the order. At this point the purchaser decides that they do not wish to purchase the goods but will return them. The purchaser will be required to state the reason from a list of reasons. The delivery agent will then enter the return into the Mobile Electronic Funds Terminal (MEFT), and the MEFT will obtain from the suppliers registration whether to, return the goods to base, return the goods to a service agency, or check with the supplier via e-mail, voice or facsimile before proceeding to return goods. These choices can be configured in the suppliers registration with the gateway to be different for local and international deliveries.

In the case of the return of an order after payment the purchaser can connect to the gateway and fill in a return form for the transaction using the unique transaction number. The gateway will then obtain a Returns Authorisation (RA) from the supplier. The RA will be transmitted to the delivery agent and will obtain the purchasers address and where the delivery entity is to take the goods to. If the payment method allows, the transaction will be reversed, refunded or a credit will be held by the gateway for the purchaser.

Any complaints with regard to the return of goods can be dealt with through the Transaction Feedback Forum.

The gateway will also have the ability to facilitate online transactions in the event of a delivery being a gift to another party. In this situation included in the transaction details would be transaction value of zero, as on delivery no payment would be required to be paid. In the case of the buyer buying for delivery as a gift to another party in some cases the gift could be taken to the buyer for final acceptance, paid for and then moved on to the intended recipient of the gift by the delivery entity.

The gateway is able to keep a record of each transaction and its details, such as buyer, seller, delivery and payment details relating to each purchase. Registrants can enter the gateway at any time and check a transaction using the unique transaction number or by browsing through a list of transactions that only the registrant has access to once their unique purchaser number or unique supplier number and password has been entered into the gateway. Through the use of the historical transaction database the purchaser can easily locate previous purchases through the gateway and make repeat orders of any goods that have previously been bought. This enables the re-order of goods without having to find which web-site the goods were obtained from.

Finally, the gateway has the ability to consolidate single buyer, multiple transactions within common delivery time frames, thus having the purpose of reducing delivery costs.

Advantages

The present invention allows for issues of repudiation to be dramatically reduced. Due to the requirement for a password from the purchaser, repudiation on the part of the purchaser denying later that he/she made the purchase becomes difficult. Although, there becomes an issue when the supplier has supplied faulty or misrepresented items. Purchasers can take any customer service issues directly with the supplier (by referring to the unique transaction identification number), escalating them to the gateway transaction feedback forum only if they don't get satisfaction from the supplier. The supplier is not automatically assumed to be in the wrong, as with traditional credit cards all communications are digitally signed, so charge backs are a much smaller issue. The gateway will reimburse the purchaser and penalise the supplier, if the supplier fails to deliver the goods as specified.

At time of delivery, if the goods sent by the supplier are clearly not what was purchased by the purchaser and he or she refuses to pay for the goods, the supplier will be charged for the delivery and return. If the purchaser refuses to take delivery or the transaction is denied through MEFT they will be advised of having signed an agreement of purchase at time of order and that there will be a penalty cost against their next transaction, or if they wish, they may pay the penalty costs immediately. These penalty costs will be the courier fees for handling, delivery and return of the goods. Therefore, recording of this type of information will allow the gateway to monitor both the supplier and the purchaser for undesirable behaviour.

Furthermore, the present invention authenticates the purchaser at point of delivery reducing fraud to the merchant and emulating real world transactions. The gateway removes the requirement for the merchant to have multiple payment systems and to maintain client records.

The gateway caters to potential purchasers who do not hold credit cards and gives some form of control to parents who will be able to limit online purchases by their children to the gateway pay-on-delivery system.

The gateway also presents the costs of the transaction to the merchant in his/her respective currency and the purchaser's respective currency, each of these costs including freight, duty, customs costs and gateway fees.

Credit Card fraudsters often prefer the Internet because there is no obligation to present a credit card in person when making a purchase and they can therefore trawl repeated sites to use a stolen card in relative anonymity. The gateway of the present invention eliminates this occurrence.

The gateway also facilitates all existing online (e.g. credit cards), off line (e.g. card present, cheque, cash) and bank only supplied payments (e.g. direct debit) providing all existing and future payment options to purchasers and giving this capability to merchant web sites without having to host multiple payment systems.

The gateway collects and manages all information exchange in relation to the fulfilment process and facilitates a central repository for purchaser transactions. Finally, the gateway provides a service to existing “Bricks and Mortar” merchants whereby they can deliver goods to clients and collect payment without running their own delivery operations.

Finally, the present invention provides low transaction costs, guaranteed payment of goods and guaranteed delivery of goods to the purchaser.

1. A system which facilitates the purchase, delivery and payment for goods by a purchaser from a supplier who sells goods from a website, where an entity operating a gateway enables said supplier to provide said purchaser with a payment option via said gateway and said gateway accepts liability for paying said supplier and a delivery entity conveys said goods from said supplier to said purchaser and collects payment from said purchaser, comprising the steps of:
a) said supplier registering with said gateway entity by providing said gateway with collection details such as an address to collect said goods from said supplier,
b) said purchaser viewing on a web enabled device said suppliers website, said purchaser selecting goods as displayed on said website by using a pointing device associated with said device and causing each selected good to be added to an electronic file forming part of said website,
c) said purchaser using said pointing device to select a payment option displayed on said website,
d) said purchaser being thereupon directed to said gateway and said electronic file being sent to said gateway,
e) said purchaser then either,
registering with said gateway providing said gateway with information which uniquely identifies said purchaser and said gateway assigns a unique identification number to said purchaser, or
if already registered, entering an already assigned unique identification number, to cause an electronic purchase order to be created by said gateway, which includes transaction identification information,
f) said purchase order with purchaser identification information omitted then being forwarded from said gateway to said supplier,
g) said gateway entity then forwarding said purchase order, said collection details of said supplier and some or all of the contents of said purchaser identification information to a delivery entity,
g) said delivery entity collecting said purchased goods from said supplier and delivering said goods to said purchaser, where upon delivery said purchaser makes a payment to said delivery entity for said goods, and
h) said payment being transferred to said gateway entity.

2. A system which facilitates the purchase, delivery and payment for goods by a purchaser from a supplier who sells goods from a website according to claim 1 including the steps of said gateway transferring at least part of said payment to said supplier.

3. A system which facilitates the purchase, delivery and payment for goods by a purchaser from a supplier who sells goods from a website according to any one of claims 1 or 2 wherein said delivery entity is a courier company equipped with a mobile electronic funds transfer terminal.

4. A system which facilitates the purchase, delivery and payment for goods by a purchaser from a web site according to any one of claims 1 to 3 including the step of:
said purchaser, after entering said unique identification number at said gateway, confirming the contact name of the purchaser, delivery address of the purchaser and delivery options, each time said purchaser makes a purchase where payment is made through said gateway.

5. A system which facilitates the purchase, delivery and payment for goods by a purchaser from a supplier who sells goods from a website, where an entity operating a gateway enables said supplier to provide said purchaser with a payment option via said gateway and said gateway accepts liability for paying said supplier and a delivery entity conveys said goods from said supplier to said purchaser and collects payment from said purchaser, comprising the steps of:
a) said supplier registering with said gateway entity by providing said gateway with collection details such as an address to collect said goods from said supplier,
b) said purchaser viewing on a web enabled device said supplier=s website, said purchaser selecting goods as displayed on said website by using a pointing device associated with said device and causing each selected good to be added to an electronic file forming part of said website,
c) said purchaser using said pointing device to select a payment option displayed on said website,
d) said purchaser being thereupon directed to said gateway and said electronic file being sent to said gateway,
e) said purchaser then either,
registering with said gateway providing said gateway with information which uniquely identifies said purchaser and said gateway assigns a unique identification number to said purchaser, or
if already registered, entering an already assigned unique identification number, to cause an electronic purchase order to be created by said gateway, which includes transaction identification information,
f) said purchaser making a payment for said goods using online payment means, where said payment is transferred to an escrow account maintained by said gateway,
g) said purchase order with purchaser identification information omitted then being forwarded from said gateway to said supplier,
h) said gateway entity then forwarding said purchase order, said collection details of said supplier and some or all of the contents of said purchaser identification information to a delivery entity,
i) said delivery entity collecting said purchased goods from said supplier and delivering said goods to said purchaser, where upon delivery said purchaser uses the delivery entity to communicate authorisation for the release of said payment from said escrow account to said gateway, and if necessary making a supplemental payment to said delivery entity for said goods and said delivery entity transferring said supplemental payment to said gateway.

6. A system which facilitates the purchase, delivery and payment for goods by a purchaser from a supplier who sells goods from a website according to claim 5 including the steps of said gateway transferring at least part of said payment or supplemental payment to said supplier.

7. A system which facilitates the purchase, delivery and payment for goods by a purchaser from a supplier who sells goods from a website according to any one of claims 5 or 6 wherein said delivery entity is a courier company equipped with a mobile electronic finds transfer terminal, to allow said purchaser to make said supplemental payment for said goods.

8. A system which facilitates the purchase, delivery and payment for goods by a purchaser from a website according to any one of claims 5 to 7 including the step of:
said purchaser, after entering said unique identification number at said gateway, confirming the contact name of the purchaser, delivery address of the purchaser and delivery options, each time said purchaser makes a purchase where payment is made through said gateway.

9. A system which facilitates the purchase, delivery and payment for goods by a purchaser from a website substantially as herein described with reference to and illustrated by the accompanying drawings.
